(19) United States
(12) Patent Application Publication
(10) Pub. No.: US 2003/0037090 A1
(43) Pub. Date: Feb. 20, 2003

(54) Tool services layer for providing tool service functions in conjunction with tool functions

(76) Inventor: Horne L. Koh, San Jose, CA (US)

Correspondence Address: APPLIED MATERIALS, INC., 2881 SCOTT BLVD. M/S 2061, SANTA CLARA, CA, 95050, US

(21) Appl. No.: 09/928,473

(22) Filed: Aug. 14, 2001

(51) Int. Cl. G06F 9/00

(52) U.S. Cl. 709/100

(57) ABSTRACT

One or more semiconductor manufacturing tools and a tool service layer are used to fulfill client requests, including manufacturing procedures and data collection steps, without referencing tool functions or tool service layer functions in the request. Initially, a service request is received from a client. Subsequently, one or more tool functions capable of being provided by the tools and one or more tool service layer functions capable of being provided by the tool service layer are identified. After these functions required for fulfilling the service request have been identified, the identified tool functions and tool service layer functions are performed, thereby fulfilling the client service request. Furthermore, in at least some embodiments, the service request need not specifically reference the substeps. Similarly, in at least some embodiments, the request does not reference the tool service layer functions required to fulfill the client request. In these situations, the required tool service layer functions are identified independently without information from the service request.

### FIELD OF THE INVENTION

The present invention relates generally to control processes used in the manufacture of semiconductor devices. More particularly, the present invention relates to systems, methods and mediums for fulfilling client requests including, for example, manufacturing and data collection steps, without requiring the client to possess knowledge of any specific substeps needed to fulfill the task.

### BACKGROUND OF THE INVENTION

An increasingly evident problem in the semiconductor manufacturing industry is the inefficient usage of equipment within semiconductor manufacturing facilities. One reason for such inefficient (e.g., low rates of) equipment utilization is the fact that today's semiconductor factory management and automation solutions are often a patchwork of derivatives and evolutions of software used to tie together a bewildering variety of components and custom modules from countless vendors. For example, factory management software initially supplied by vendors is often modified by the purchaser/user with the thought of attaining competitive advantages. However, years of adding and modifying additional functions and tools on top of existing systems has produced a difficult to navigate and fragmented software sprawl. Consequently, this patchwork of software solutions has made it difficult to manage traditional manufacturing operations.

One of the problems arising from this fragmented system has been the difficulty associated with communicating between the clients (e.g., any entity requesting a service that can be performed by another entity such as a tool) and the various tools in a factory. For instance, the tools from a particular vendor, or a certain family of tools, typically utilize a communication protocol unique to that class of tools. This may be manageable with a small number of protocols. However, many manufacturing facilities consist of hundreds of independent tools or modules. For these situations, client requests have to be tailored to comport with each of the protocols of all of the tools in the facility for the facility to operate properly.

To further complicate the situation described above, each service request may, in actuality, require a number of additional and possibly complicated operations or sub-steps, any of which potentially being highly dependent on one or more preceding (or subsequent) steps not normally handled by a tool. For instance, before performing a photolithography procedure, one or more lots of materials must be delivered to a photolithography tool. However, the tool itself does not provide the functionality required to move or handle the lots. Thus, services other than those provided by the tools are necessary to fulfill a particular client request. To require the client to be aware of these other services increases the complexity of the system and results in management systems that are difficult to implement.

Consequently, there is a need for a manufacturing system capable of fulfilling not only the actual client requests or tool services, but also for providing other related services within a manufacturing environment containing a variety of different types of machinery and software. Similarly, there is a need for a technique for utilizing and implementing these related services without requiring the client to be aware of any substeps needed to fulfill the client request.

### SUMMARY OF THE INVENTION

The present invention addresses the problems described above by providing techniques for utilizing one or more tools and a tool service layer to fulfill client service requests. In at least some embodiments, these service requests may be fulfilled by performing one or more tool functions, one or more tool service layer functions, or a combination of one or more tool functions and one or more tool service layer functions. At least some of the tool functions may include the substeps actually required to provision a tool job including, for example, initializing a tool, elevating or lowering a pressure, filling a chamber with a gas, turning on pumps, etc. At least one function of the tool service layer as contemplated by at least some embodiments of the present invention is to receive requests for a tool function (e.g., perform a photolithographic procedure) from a client, determine what other related functions (hereafter “tool service layer functions”) need to be performed (e.g., deliver materials to the photolithography tool), and implement those functions. Thus, in operation of at least some embodiments of the present invention, a service request from a client is first received. Subsequently, one or more tool functions capable of being provided by the one or more tools available in the manufacturing facility and one or more tool service layer functions capable of being provided by the tool service layer are identified. In these embodiments, the tool functions and tool service layer functions are required (or at least desired) to fulfill the service request. From there, the identified one or more tool functions and the one or more tool service layer functions are performed, thereby fulfilling the client service request.

Also, in at least some embodiments of the present invention, the service request does not reference the one or more tool functions or the one or more tool service layer functions. In these embodiments, the tool functions or the tool service layer functions are first identified and are then subsequently performed.

### BRIEF DESCRIPTION OF THE DRAWINGS

Various objects, features, and advantages of the present invention can be more fully appreciated as the same become better understood with reference to the following detailed description of the present invention when considered in connection with the accompanying drawings, in which:

FIG. 1A is a block diagram of one example of a system utilizable for implementing concepts of at least some embodiments of the present invention;

FIG. 1B is a detailed illustration of a portion of the system of FIG. 1A including a number of computing nodes, a routing device, a database and a processing node;

FIG. 2 depicts one example of a process utilizable for registering a tool service component as contemplated by at least some embodiments of the present invention;

FIG. 3 depicts one example of a process utilizable for routing a client request to a tool service component as contemplated by at least some embodiments of the present invention;

FIG. 4 depicts one example of at least one process utilizable for fulfilling a client request as contemplated by at least some embodiments of the present invention;

FIG. 5 is a combined system and process diagram illustrating a process utilizable for fulfilling a client request as contemplated by at least some embodiments of the present invention;

FIG. 6 is a high-level block diagram depicting aspects of computing devices contemplated as part of, and for use with, at least some embodiments of the present invention; and

FIG. 7 illustrates one example of a memory medium which may be used for storing a computer implemented process of at least some embodiments of the present invention.

### DETAILED DESCRIPTION OF THE INVENTION

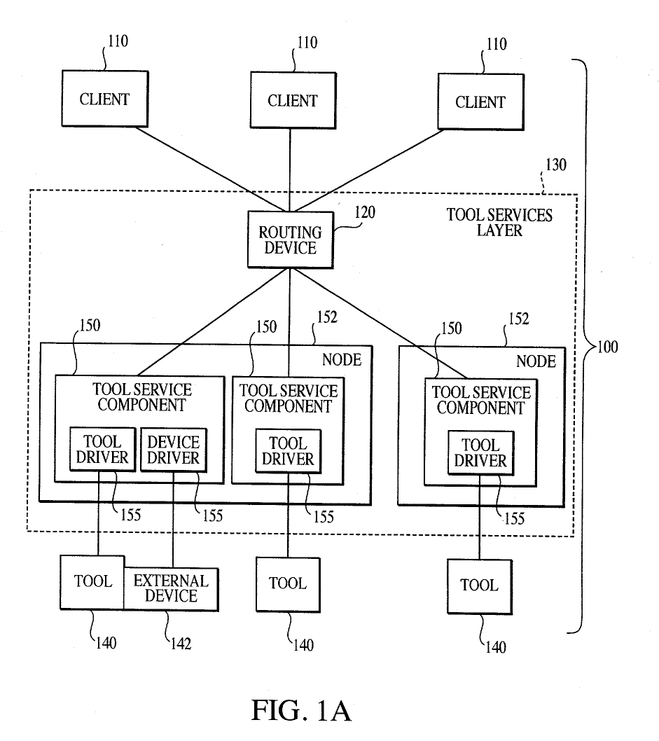

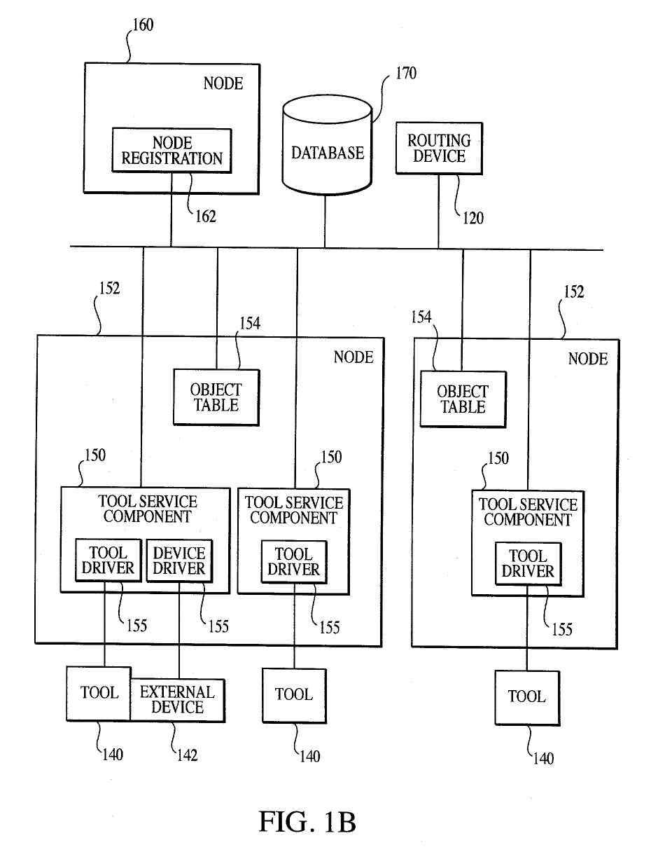

FIG. 1A illustrates one example of a system utilizable for implementing concepts of at least some embodiments of the present invention. More particularly, system 100 is a block diagram representation of a semiconductor manufacturing system, and in at least some embodiments of the present invention includes a number of interconnected components. For example, system 100 may include a number of client processes or clients 110, a routing device 120, a tool services layer 130, a number of computing nodes 152, and a number of tools 140.

Clients 110 can include any number of entities that may require the provisioning of a service. For instance, a call for a service may be made in the form of a request transmitted from a device on which a process is running. Examples of devices capable of executing clients 110 include monitoring applications, tool status display panels, user interfaces, etc. In use, the clients may be used to request the performance of a tool job or tool service such as a polishing process or to request the collection of data from, for example, a sensor. In addition, a client may include a workflow (i.e., a call to execute another workflow). Generally speaking, a workflow may include the preprogrammed, or scripted sequence of steps or tasks required to complete a job. Each step in turn may request the provisioning of one or more services, or cause another workflow to be executed. Thus, one step of a workflow is capable of and may be utilized to request a service.

Tools 140 include the modules and equipment utilized in a standard manufacturing facility for producing, or taking measurements of, semiconductors. For instance, examples of tools 140 include devices for implementing oxidation, photolithography, implanting, metrology services, etc. Tools 140 may also include devices such as sensors or auxiliary hardware internal or external to semiconductor processing, metrology, or packaging tools (e.g., external devices 142).

Referring to FIG. 1B, nodes 152 can include any computing devices such as personal computers, workstations, etc., and may be used to implement one or more tool service component 150. Each tool service component may also include one or more tool driver components (or device drivers) 155 to assist in communicating with tools 140 (or external devices 142). Specifically, one or more tool service components 150 implemented on nodes 152 provide the functionality required to communicate between clients 110 and tools 140. In particular, utilizing software and/or hardware processes, each tool service component 150 serves as a logical abstraction of a tool and represents an actual tool instance. Thus, client requests intended for delivery to an associated tool are received and initially processed by tool service components 150.

Subsequently, the tool driver components 155 convert or translate the client request into a communication protocol acceptable to its associated tool. Each tool service component may include multiple tool drivers. Each tool driver, in turn, may communicate with the actual tools 140, and/or devices that are internal or external to the tools. For example, a tool service component may have one tool driver communicate with one tool, and another tool driver communicate with a device attached to (or otherwise in communication with) the tool such as external device 142. Examples of external devices include bar code readers, sensors, etc. In this manner, the tool service component 150 provides a greater level of abstraction and flexibility than would be available if each client was required to communicate directly with the tools. For instance, a client may request (from the tool service component) data originating from the tool or the device. Since the tool service component represents the logical tool, the client does not know, or care how the tool service component retrieves the requested data.

As depicted in FIG. 1B, in addition to including tool service components 150, each node 152 may include an object table 154. As will be described below, these object tables 154 may be utilized to store or manage object references used to identify and call the specific instance of the tool service component running on the nodes. Thus, tool service components 150 are used to command tools 140 and receive communications from the tools as well.

In addition, a node 160 running a node registration process 162 may be implemented to register each of the nodes in which a tool service component has been launched. Thus, the node registration process 162 may be utilized to store and withdraw, from a central database 170, the node identifiers (node IDs) of each of the nodes on which a tool service component has been launched. Although in this example node 160 is used to manage database 170 (i.e., store and retrieve node IDs in database 170), in other examples database 170 may be managed directly by nodes 152. Furthermore, any medium may be used in place of database 170 (e.g., any storage file or the like) to store information.

Database 170 is utilized to store, in addition to the node IDs discussed above, configuration information used to identify whether a service may be provided by a tool or by the tool services layer. Thus, the configuration information relating to a tool may include the characteristics of the tool such as its name, number of ports, material capacity, etc. Likewise, the configuration information relating to the tool services layer may include the characteristics of any explicitly defined services and other services that may be provisioned. The configuration information may also include any user defined or predefined workflows for executing an automation scenario (i.e., executing a workflow to address a sequence of discrete tasks). At least some embodiments of the present invention contemplate that the configuration information may be entered by a user (e.g., a process engineer or the like) into database 170 using a configuration application or the like.

Referring back to FIG. 1A, at least some embodiments of the present invention contemplate that in order to adequately fulfill a client service request a number of other substeps or functions may be required (that are not otherwise automatically implemented by virtue of receipt and implementation of the client request). Specifically, in some situations, a request may be fulfilled only by performing one or more additional substeps or tasks performed by a tool, the tool services layer, or a combination of the two. For example, in addition to the polishing job itself, a polishing process may require tool functions such as substeps for initializing the tool, setting recipe parameters, etc., and/or tool service layer functions such as substeps for loading the polisher, collecting data during polishing and analyzing the results for future runs. Furthermore, at least some embodiments of the present invention contemplate that some services may not require a tool function (i.e., an action by a tool). In these cases, the services may be provided by tool services layer 130 (i.e., a tool service layer function). For example, a fault detection procedure may be utilized to monitor the health of a tool without requiring the services of the tool itself. Thus, a service request may be fulfilled by providing a tool function, a tool service layer function, or a combination of the two. Whatever the case may be, at least some embodiments of the present invention contemplate that the client request need not make any reference to the specifics (i.e., any of the substeps, any command protocols or formats, or whether a tool or the tool services layer is providing the service) of the requested service, or have any knowledge even of the existence of any component or process other than the requested job.

Routing device 120 is responsible for delivering the client requests to an appropriate tool service component 150 via locating its object reference and calling its method responsible for performing a tool function or a tool service layer function. Typically speaking, these client requests identify a desired tool service offered by a tool, and routing device 120 identifies the object reference associated with the desired service and calls the method of the object. For instance, one step in a workflow may request that a particular polishing technique be applied to one or more lots of material. Furthermore, at least some embodiments of the present invention contemplate that the client requests make no reference to nor have any knowledge of the actual services or specifics (e.g., substeps, command parameters or formats, etc.) or details required to fulfill the requested job. For example, the above mentioned polishing technique may require a monitoring process to be run from a sensor during polishing to determine when to terminate the actual polishing process.

Routing device 120 includes any number or combination of software processes working in a coordinated manner and, in conjunction with tool services layer 130, is responsible for identifying an object reference associated with the tools capable of providing a requested service and calling the appropriate method of the object. Similarly, tool services layer 130 is responsible for determining those instances where the tool services layer itself is capable of providing a service. In those situations, a tool may not be required to satisfy the request. Instead, the request may be fulfilled by the tool services layer 130. In other situations, the request may be fulfilled by a combination of services provided by the tool and the tool services layer. Further, tool services layer 130 may be utilized to identify predefined workflows for controlling the execution of a job (which may include, for example, a step of a workflow, etc.). In these cases, the workflow to be called may be retrieved from, for example, a remote or local database (such as database 170) and subsequently launched as one or more of clients 110. From there, the workflow may make any number of additional client requests, including for example executing other workflows. Thus, a workflow responsible for carrying out the main automation process may in turn call other workflows for performing one or more substeps including, for example, exception handling routines.

As discussed above, routing device 120 is responsible for routing the client requests to the appropriate tool service component. In this manner, any number of clients may be able to request services from any number of tools (i.e. multiple clients may request the services of a single tool, or a client may request the services of multiple tools). Furthermore, tool services layer 130 may also include other application components in addition to routing device 120 and tool service components 150. Thus, extensibility of the system through the addition of custom software and hardware components is facilitated.

As mentioned above, at least some embodiments of the present invention contemplate that tool services layer 130 is responsible for accepting or receiving any number of requests from clients 110. Again, these requests need not reference the specifics of the requested service, or have any knowledge even of the existence of any component or process other than the requested job. In this manner, the client requests need not comport with the idiosyncrasies and protocols of each of the tools. Instead, tool services layer 130 is configured to translate and convert client requests into a format recognizable by each of tools 140. Accordingly, tool service components 150 may be viewed by clients 110 as a representation of each of tools 140.

Furthermore, the software and hardware processes of tool service component 150 are responsible for determining whether the functions are capable of being provided by any of tools 140 or by tool service layer 130. Specifically, the tool service components determine the substeps required to facilitate provisioning of the tool service. In the event that more than tool functions are required to fulfill the service, tool service layer 130 is responsible for identifying and provisioning these additional tool service layer functions.

As depicted in FIG. 1A, in some cases, tool services layer 130 is distributed on tool service component 150 and routing device 120. In other cases, tool services layer 130 may be implemented solely in routing device 120 or solely in tool service component 150.

As mentioned above, at least some embodiments of the present invention contemplate that configuration information may be entered using a registration process before (or during) process execution. Once the configuration information has been entered, it may be forwarded to, for example, tool services layer 130 during system initialization. From there, the configuration information may be used to, for example, identify the functions capable of being provided by the individual tools 140 and the tool services layer 130.

In general, it should be understood that the components mentioned in FIGS. 1A and 1B, as well as their specific configurations, are by way of example, and that the present invention contemplates any number of alternative components and/or configurations as well.

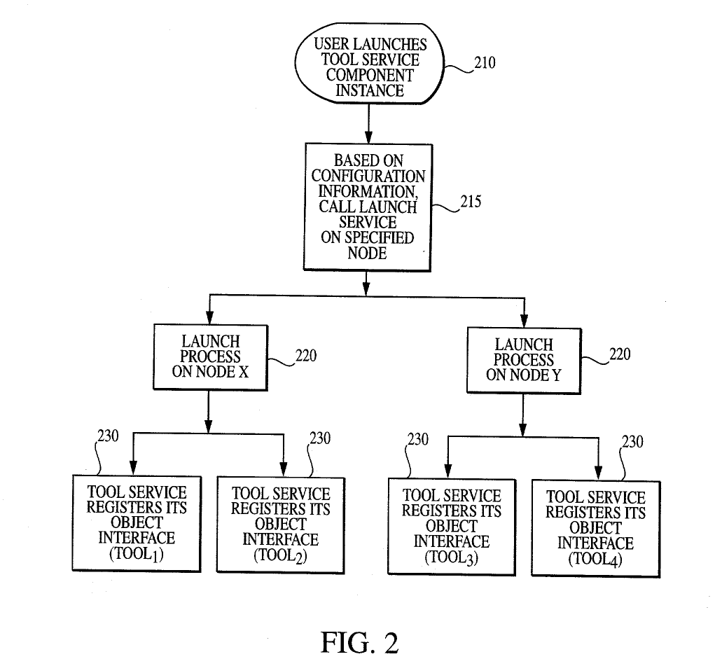

Referring to FIG. 2, one example of a process utilizable for registering a tool service component is described. In this regard, the function provided by the associated tool may be registered once a tool service component has been launched and successfully initialized, and subsequently becomes available to clients 110. As a starting point in the process, from a workstation, a user (i.e., a process engineer, operator or the like) selects and launches a service (STEP 210). Based on configuration information (which identifies, for example, the node in which to run the tool service components), the nodes capable of providing the selected service are identified. Subsequently, a request is made to a, for example, launch service process (i.e., a remote agent or the like on each of the nodes) to launch the tool service components (STEP 215). The launch service process on each identified node then launches a tool service component process for each tool (or set of tools grouped as one logical tool) (STEP 220). Then, the tool service component process creates the tool service component object. From there, each tool service component object registers its object reference identifying itself with an object table 154 and a node ID identifying its node with database 170 (STEP 230).

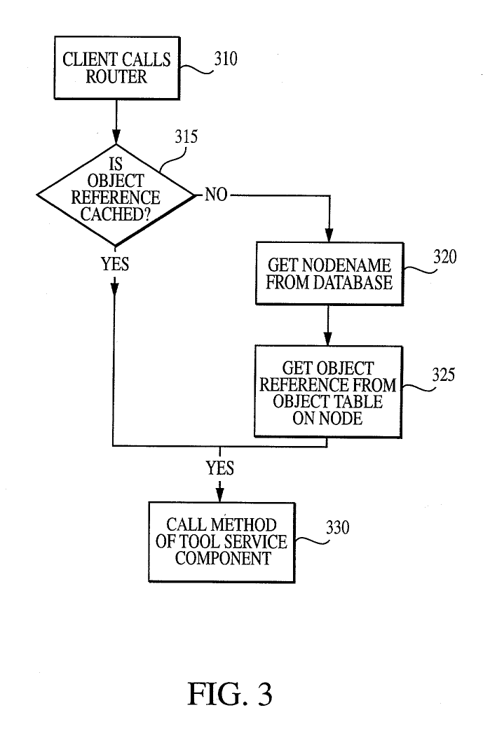

Referring to FIG. 3, one example of a process utilizable for routing a client request to a tool service component 150 is illustrated. Once the request has been received, the tool function may be performed. Initially, a client request is transmitted to and received by routing device 120 (STEP 310). In response to the client request, routing device 120 examines a cache memory for a tool service component object reference corresponding to the client's request (STEP 315). In particular, at least some embodiments of the present invention contemplate that information (e.g., the tool service component object reference) required to fulfill the client request may be stored locally on routing device 120. For example, an identical or similar request may have been recently fulfilled. Thus, information relating to recently called tools and tool service layer functions (e.g., hostnames, etc.) remain in cache memory.

In these cases, if information required to fulfill the client request is stored locally on routing device 120, the tool service component corresponding to the requested service is called (STEP 330), resulting in the performance of tasks needed for the provisioning of the requested service.

If information required to fulfill the client request is not stored locally on routing device 120, the node ID corresponding to the node running the tool service component capable of providing the requested service is obtained (STEP 320). Specifically, routing device 120 calls node registration service 162 or database 170 directly with the tool name which returns the node ID (i.e. computer hostname) on which the requested tool service component process has been launched. Using this node ID, the tool service component object reference associated with the requested tool is obtained (STEP 325). In particular, the object table on the identified node is examined for an object reference corresponding to the client request, after which the tool service component object reference is returned. In this manner, the tool service component instance required to fulfill the client request may be identified.

Although FIG. 3 depicts a specific process for routing a client request to a tool service component, it is to be understood that other routing procedures are also utilizable in conjunction with the concepts of the present invention. For instance, any standard industry routing procedures including, for example, those that locate object references directly on the computing nodes without utilizing a manager process or external database may also be utilized.

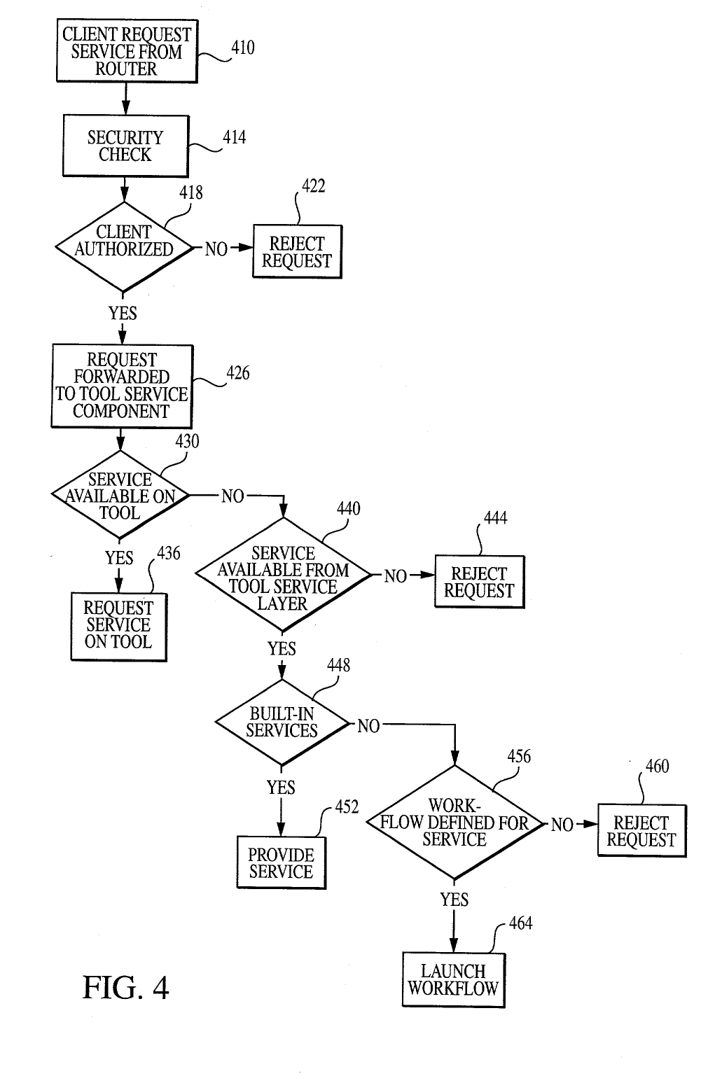

Referring to FIG. 4, one example of at least one process utilizable for fulfilling a client request is illustrated. Initially, the client request is received by tool services layer 130 and by the tool service component identified utilizing the exemplary process of FIG. 3 (STEP 410). In response, a security check is performed to verify that the client is authorized to receive the requested service (STEP 414). Generally speaking, any industry standard security process may be utilized. If the client is authorized to receive the requested service (STEP 418), the client request is forwarded to the corresponding tool service component (STEP 426). On the other hand, if the client is not authorized to receive the requested service (STEP 418), the request is rejected (STEP 422).

After the request has been forwarded to the tool service component, the configuration information is examined to identify whether the tool corresponding to the tool service component is capable of performing the functions required to provide the requested service (STEP 430). For example, the configuration information may explicitly indicate which functions are capable of being performed by the tool. If the tool is capable of performing the functions required to provide the requested service, the service is requested from that tool (STEP 436), and subsequently provided.

If after reviewing the configuration information, it is determined that the requested service is not available on the tool, tool service component 150 determines whether it is capable of performing the functions required to provide requested service (STEP 440). For example, the configuration information may indicate each of the functions capable of being provided by the tool services layer 130. In particular, similar to the step of ascertaining whether the service is available on the tool, tool service component 150 may examine the configuration information to determine whether it, either alone or in conjunction with the tool services layer 130, is capable of performing the functions required to provide the service.

If tool service component 150 determines that it, or the tool services layer 130 is not capable of performing the functions required to provide the requested service (STEP 440), the request is rejected (STEP 444).

However, if tool service component 150 determines that it or the tool services layer 130 is capable of performing the functions required to provide the requested service (STEP 440), it then determines whether the service is a service built into tool services layer 130 (STEP 448). Specifically, a service is a built in service if it is a predetermined or known service. Thus, a built in service includes processes implemented in code or script to provide that specific service. Furthermore, additional information required to perform the built in service may be obtained from configuration information.

If it is determined that the service is a built in service, the service is provisioned (STEP 452).

If on the other hand it is determined that the service is not built into the tool services layer 130 (STEP 448), tool services layer 130 identifies whether a workflow has been defined for provisioning the requested service (STEP 456). In these cases, a workflow may be predefined to provide a requested service or to accomplish one or more steps of another workflow. For instance, tool services layer 130 checks the configuration information for the name of a predefined (preprogrammed) workflow defined by, for example, a process engineer. As mentioned above, the workflow thus may be utilized in an automation scenario (i.e., implementing a workflow to address a specific sequence of discrete tasks). More specifically, workflows may be retrieved from, for example, database 170, and executed as, for example, one or more of clients 110 to provide a service (which may have been requested by one step of another workflow). In this manner, a workflow may be defined to accomplish a particular task, which may constitute a subtask of another workflow.

If a workflow for provisioning the requested service is defined, that workflow is launched (e.g., through workflow launch agents and the like) (STEP 464). In contrast, if a workflow for provisioning the requested service is not defined, the request is rejected (STEP 460).

In the above manner, at least some embodiments of the present invention aggregate the functionality of tools 140 with functionality of the tool services layer 130.

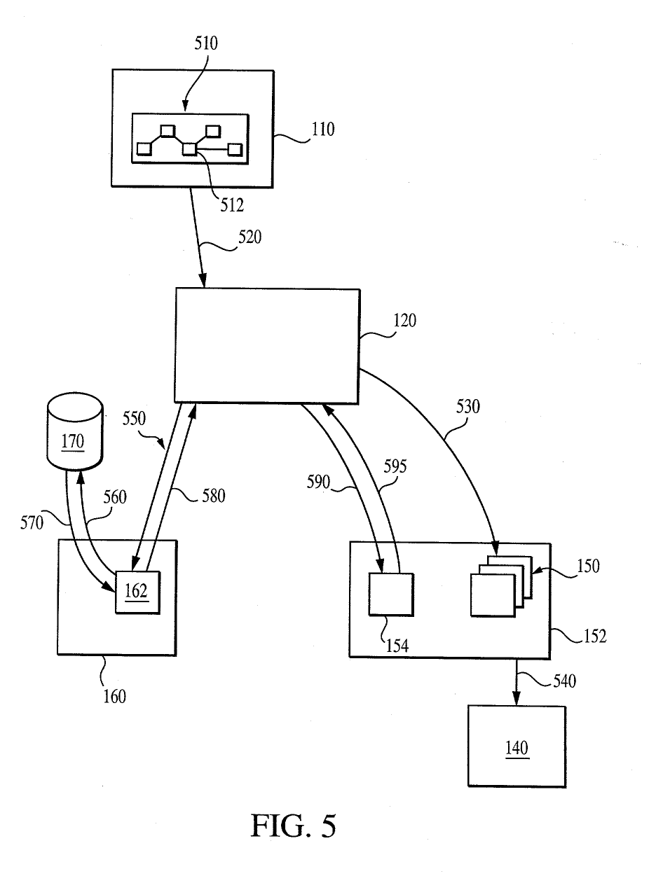

FIG. 5 depicts a combined system and process diagram illustrating a process utilizable for fulfilling a client request. In FIG. 5, a workflow 510 is shown as having been launched in client 110 (which in turn may be a step in another workflow). During execution, a step 512 in workflow 510 makes a client request (STEP 520). This client request is then received by routing device 120. Subsequently, routing device 120 checks cache memory for a tool service component object reference corresponding to the client's request.

If a tool service component object reference corresponding to the client request is stored in cache memory, the request is transmitted to the identified tool service component 150 in node 152 (STEP 530). After receiving the request, the tool service component 150 calls tool 140 (STEP 540) through tool driver 155, which in turn fulfills the client's request.

On the other hand, if a tool service component object reference corresponding to the client request is not stored in cache memory of routing device 120, routing device 120 queries node registration process 162 for a node ID corresponding to the client request (STEP 550). In response, node registration process 162 searches database 170 (STEP 560) and retrieves a node ID identifying a node running the tool service component process capable of providing the requested service (STEP 570).

The node ID retrieved by node registration process 162 is then forwarded to routing device 120 (STEP 570), which in turn queries an object table 154 implemented in the node identified by the node ID. Specifically, object table 154 is queried for an object reference running the tool service component capable of providing the requested service (STEP 590). After identifying the appropriate tool service component, the object reference corresponding thereto is returned to routing device 120 (STEP 595).

Using the object reference, the routing device transmits the client request to the identified tool service component 150 in node 152 (STEP 530). After receiving the request, the tool service component 150 calls tool 140 (STEP 540) through the tool driver 155, which in turn fulfills the client's request.

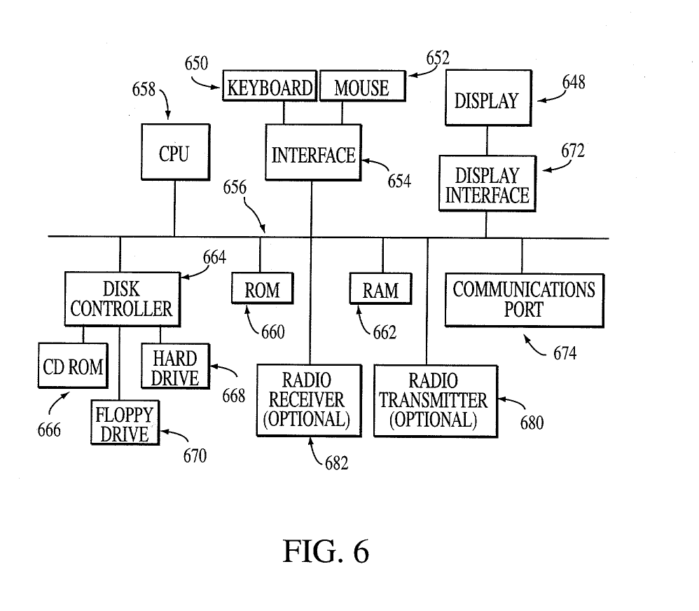

FIG. 6 illustrates a block diagram of one example of the internal hardware of client 110, routing device 120, node 152 and/or tool 140. A bus 656 serves as the main information link interconnecting the other components of system 115. CPU 658 is the central processing unit of the system, performing calculations and logic operations required to execute the processes of the instant invention as well as other programs. Read only memory (ROM) 660 and random access memory (RAM) 662 constitute the main memory of the system. Disk controller 664 interfaces one or more disk drives to the system bus 656. These disk drives are, for example, floppy disk drives 670, or CD ROM or DVD (digital video disks) drives 666, or internal or external hard drives 668. CPU 658 can be any number of different types of processors, including those manufactured by Intel Corporation or Motorola of Schaumberg, Ill. The memory/storage devices can be any number of different types of memory devices such as DRAM and SRAM as it well as various types of storage devices, including magnetic and optical media. Furthermore, the memory/storage devices can also take the form of a transmission.

A display interface 672 interfaces display 648 and permits information from the bus 656 to be displayed on display 648. Display 648 is also an optional accessory. Communications with external devices such as the other components of the system described above, occur utilizing, for example, communication port 674. For example, port 674 may be interfaced with a bus/network linked to one of nodes 152 and the like. Optical fibers and/or electrical cables and/or conductors and/or optical communication (e.g., infrared, and the like) and/or wireless communication (e.g., radio frequency (RF), and the like) can be used as the transport medium between the external devices and communication port 674. Peripheral interface 654 interfaces the keyboard 650 and mouse 652, permitting input data to be transmitted to bus 656. In addition to these components, the control system also optionally includes an infrared transmitter 678 and/or infrared receiver 676. Infrared transmitters are optionally utilized when the computer system is used in conjunction with one or more of the processing components/stations that transmits/receives data via infrared signal transmission. Instead of utilizing an infrared transmitter or infrared receiver, the control system may also optionally use a low power radio transmitter 680 and/or a low power radio receiver 682. The low power radio transmitter transmits the signal for reception by components of the production process, and receives signals from the components via the low power radio receiver.

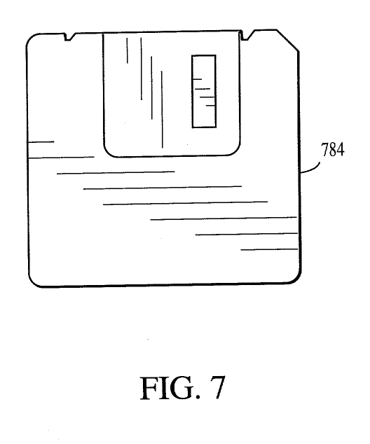

FIG. 7 is an illustration of an exemplary computer readable memory medium 784 utilizable for storing computer readable code or instructions. As one example, medium 784 may be used with disk drives illustrated in FIG. 6. Typically, memory media such as floppy disks, or a CD ROM, or a digital video disk will contain, for example, a multi-byte locale for a single byte language and the program information for controlling the above system to enable the computer to perform the functions described herein. Alternatively, ROM 660 and/or RAM 662 can also be used to store the program information that is used to instruct the central processing unit 658 to perform the operations associated with the instant processes. Other examples of suitable computer readable media for storing information include magnetic, electronic, or optical (including holographic) storage, some combination thereof, etc.

At least some embodiments of the present invention contemplate that various portions of software for implementing the various aspects of the present invention as previously described can reside in the memory/storage devices.

In general, it should be emphasized that the various components of at least some embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using C++ or Visual Basic programming languages.

It is also to be appreciated and understood that the specific embodiments of the invention described hereinbefore are merely illustrative of the general principles of the invention. Various modifications may be made by those skilled in the art consistent with the principles set forth hereinbefore.

What is claimed is:

1. A method for fulfilling client tool service requests by utilizing a tool service layer, said method comprising the steps of:
(1) receiving a tool service request from a client;
(2) identifying one or more tool service layer functions capable of being provided by said tool service layer, wherein said identified one or more tool service layer functions are required to fulfill said tool service request; and
(3) performing said identified one or more tool service layer functions, thereby fulfilling said client tool service request.

2. The method of claim 1, wherein said tool service request may be fulfilled by one or more tool functions provided by one or more tools in conjunction with said one or more tool service layer functions, and wherein said tool service request does not reference said one or more tool functions.

3. The method of claim 1, wherein said tool service request does not reference said one or more tool service layer functions.

4. The method of claim 1, wherein said step of identifying further comprises identifying a workflow for executing an automation scenario.

5. The method of claim 1, wherein said tool service request may be fulfilled by one or more tool functions provided by one or more tools in conjunction with said one or more tool service layer functions, and wherein said step of identifying further comprises reviewing configuration information describing tool functions capable of being provided by said one or more tools.

6. The method of claim 1, wherein said step of identifying further comprises reviewing configuration information describing tool service layer functions capable of being provided by said tool service layer.

7. The method of claim 1, wherein said step of identifying further comprises reviewing configuration information describing workflow definitions.

8. The method of claim 1, wherein said tool service request may be fulfilled by one or more tool functions provided by one or more tools in conjunction with said one or more tool service layer functions, and wherein said method further comprises the step of converting said client request into a format understandable by said one or more tools.

9. A system for fulfilling client tool service requests by utilizing a tool service layer, said system comprising:
a memory;
a processor in communication with said memory, wherein said processor is configured to receive a tool service request from a client via a routing device;
wherein said tool services layer is implemented in said processor and is configured to identify one or more tool service layer functions required to fulfill said tool service request; and
wherein said processor is configured to cause said identified one or more tool service layer functions to be performed by said tool services layer to fulfill said client tool service request.

10. The system of claim 9, wherein said tool service request may be fulfilled by one or more tool functions provided by one or more tools in conjunction with said one or more tool service layer functions, and wherein said tool service request does not reference said one or more tool functions.

11. The system of claim 9, wherein said tool service request does not reference said one or more tool service layer functions.

12. The system of claim 9, wherein said processor is capable of identifying a workflow for executing an automation scenario.

13. The system of claim 9, wherein said tool service request may be fulfilled by one or more tool functions provided by one or more tools in conjunction with said one or more tool service layer functions, and wherein said processor is capable of reviewing configuration information describing tool functions capable of being provided by said one or more tools.

14. The system of claim 9, wherein said processor is capable of reviewing configuration information describing tool service layer functions capable of being provided by said tool service layer.

15. The system of claim 9, wherein said processor is capable of reviewing configuration information describing workflow definitions.

16. The system of claim 9, wherein said tool service request may be fulfilled by one or more tool functions provided by one or more tools in conjunction with said one or more tool service layer functions, and wherein said processor is capable of converting said client request into a format understandable by said one or more tools.

17. A computer program embodied on a computer readable medium for fulfilling client tool service requests by utilizing a tool service layer, said computer program comprising:
computer readable instructions for receiving a tool service request from a client;
computer readable instructions for identifying one or more tool service layer functions capable of being provided by said tool service layer, wherein said identified one or more tool service layer functions are required to fulfill said tool service request; and
computer readable instructions for performing said identified one or more tool service layer functions, thereby fulfilling said client tool service request.

18. The computer program of claim 17, wherein said tool service request may be fulfilled by one or more tool functions provided by one or more tools in conjunction with said one or more tool service layer functions, and wherein said tool service request does not reference said one or more tool functions.

19. The computer program of claim 17, wherein said tool service request does not reference said one or more tool service layer functions.

20. The computer program of claim 17, wherein said computer readable instructions for identifying further comprises computer readable instructions for identifying a workflow for executing an automation scenario.

21. The computer program of claim 17, wherein said tool service request may be fulfilled by one or more tool functions provided by one or more tools in conjunction with said one or more tool service layer functions, and wherein said computer readable instructions for identifying further comprises computer readable instructions for reviewing configuration information describing tool functions capable of being provided by said one or more tools.

22. The computer program of claim 17, wherein said computer readable instructions for identifying further comprises computer readable instructions for reviewing configuration information describing tool service layer functions capable of being provided by said tool service layer.

23. The computer program of claim 17, wherein said computer readable instructions for identifying further comprises computer readable instructions for reviewing configuration information describing workflow definitions.

24. The computer program of claim 17, wherein said tool service request may be fulfilled by one or more tool functions provided by one or more tools in conjunction with said one or more tool service layer functions, and wherein said computer program further comprises computer readable instructions for converting said client request into a format understandable by said one or more tools.

25. A system for fulfilling client tool service requests by utilizing a tool service layer, said system comprising:
means for receiving a tool service request from a client;
means for identifying one or more tool service layer functions capable of being provided by said tool service layer, wherein said identified one or more tool service layer functions are required to fulfill said tool service request; and
means for performing said identified one or more tool service layer functions, thereby fulfilling said client tool service request.

26. The system of claim 25, wherein said tool service request may be fulfilled by one or more tool functions provided by one or more tools in conjunction with said one or more tool service layer functions, and wherein said tool service request does not reference said one or ore tool functions.

27. The system of claim 25, wherein said tool service request does not reference said one or more tool service layer functions.

28. The system of claim 25, wherein said means for identifying further comprises means for identifying a workflow for executing an automation scenario.

29. The system of claim 25, wherein said tool service request may be fulfilled by one or more tool functions provided by one or more tools in conjunction with said one or more tool service layer functions, and wherein said means for identifying further comprises means for reviewing configuration information describing tool functions capable of being provided by said one or more tools.

30. The system of claim 25, wherein said means for identifying further comprises means for reviewing configuration information describing tool service layer functions capable of being provided by said tool service layer.

31. The system of claim 25, wherein said means for identifying further comprises means for reviewing configuration information describing workflow definitions.

32. The system of claim 25, wherein said tool service request may be fulfilled by one or more tool functions provided by one or more tools in conjunction with said one or more tool service layer functions, and wherein said system further comprises means for converting said client request into a format understandable by said one or more tools.

33. A system for fulfilling client tool service requests comprising:
a processor;
a memory, said memory in communication with said processor, and including:
a tool service layer, configured to receive a tool service request from a client, wherein said tool services layer is configured to identify one or more tool service layer functions required to fulfill said tool service request; and
a tool service component, configured to cause said identified one or more tool service layer functions to be performed by said tool services layer, thereby fulfilling said client tool service request.

34. The system of claim 33, wherein said tool services layer is capable of identifying a workflow for executing an automation scenario.

35. The system of claim 33, wherein said tool services layer is capable of reviewing configuration information describing tool service layer functions capable of being provided.

36. The system of claim 33, wherein said tool services layer is capable of reviewing configuration information describing workflow definitions.
